(19) United States
(12) Patent Application Publication
(10) Pub. No.: US 2003/0093504 A1
(43) Pub. Date: May 15, 2003

(54) Method for processing data containing information about an electronic circuit having a plurality of hierarchically organized networks, computer readable storage medium and data processing system containing computer-executable instructions for performing the method

(76) Inventors: Tilmann Neunhoeffer, Unterhaching (DE); Peter Baader, Munchen (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 10/284,772

(22) Filed: Oct. 31, 2002

(30) Foreign Application Priority Data
Oct. 31, 2001 (DE) 101 54 960.1
Nov. 30, 2001 (DE) 101 60 459.9

(51) Int. Cl. G06F 15/177

(52) U.S. Cl. 709/220; 709/223

(57) ABSTRACT

A method for processing data containing information about an electronic circuit having a plurality of hierarchically organized networks is disclosed. The method involves processing the data which represent the circuit to be tested such that all the networks of the circuit are checked in hierarchical order for an association with a network type. If such an association is established, it is transferred to the data record for the network at the top of the hierarchy (i.e., top network). The association is then transferred to the data records for the subnetworks associated with the top network (in the opposite hierarchical order). The knowledge of the association between each network and the network type can then be used for a plausibility check of the circuit. Further, a computer readable storage medium and a data processing system contain computer-executable instructions for performing the method.

### BACKGROUND OF THE INVENTION

Field of the Invention

The invention relates to a method for processing data containing information about an electronic circuit having a plurality of hierarchically organized networks. The method is based on a network list, i.e., a list containing components and networks. They can be distributed over hierarchically structured cells. The invention also relates to a computer readable storage medium and a data processing system containing computer-executable instructions for performing the method.

For example, single cells contain all of the components and networks, which together form an inverter. Such a cell B can then be instantiated (used) in another cell A. Thus, cell A contains not only components and networks, but also a call from cell B to particular networks (“pins”). Such a network list is also referred to as a “hierarchical” list. Any number of hierarchical levels can exist in a layout on an overall chip. Cells used in other cells are referred to as instantiated cells. The components in these cells are identical in all instantiations. However, they have different environments.

It is important to check (during the various phases of circuit configuration) as to what network types the particular components are linked to. A network generally refers to the conductive connection between various components, i.e., between a transistor output and a transistor input. In this case, networks of different types generally refer to the electrical lines which connect particular connections to the components of a semiconductor circuit. By way of example, a network of the “power network” type connects a power supply to the supply inputs for a chip and hence to the components of the chip. Other examples include “ground networks”, “input networks”, “output networks”, etc.

Particular components need to be connected to networks of particular types in accordance with prescribed rules. For example, the bulk connections on NMOS transistors need to be connected to ground, and those on PMOS transistors need to be connected to “power”. In addition, particular “configuration rules” exist for some components which are close to external chip connections, since these components can be subject to higher voltages than components in the “interior” of the circuit. For example, rules for constructing a chip for protection against static discharges (Electrical Static Discharging ESD) also exist. In this case too, verification of the circuit (to be checked) requires the knowledge of what network types that the components of the circuit are linked to.

When the circuit is configured, it is desirable to simulate the electrical response (without having constructed the circuit already). This is achieved using the network list, whose information content corresponds to that of a schematic. Examples of conventional network list formats include SPICE and DSPF.

The identification of network types may be a problem, depending on the organization of the network list for a network to be verified. It is generally not a problem to identify the network types for the network lists which are not organized in a hierarchy (i.e., “flat” network lists), since each network has a unique, direct type association.

In contrast, in hierarchical network lists, the information is organized in a hierarchy. In other words, “repeatedly occurring structures” are described only once and are referenced at the required locations.

Hierarchical organization of the data is imperative for today's chips, since this is the only way in which repetitive network structures for individual cells need to be stored only once in order to restrict the memory and computation requirements when configuring circuits and verifying integrated semiconductor circuits.

Physically cohesive networks are often distributed over several of such cells in hierarchical networks. In other words, cells often contain only parts of a network (“subnetworks”). However, associations with a network type are made only in relation to a complete network, and not in relation to such subnetworks. If the network list is examined in relation to individual cells, then a situation arises in which cells have a subnetwork that has no network type association, since the association is contained in another subnetwork.

When the “circuit configuration” is completed, “plausibility checks” are performed. Conventionally, plausibility checks are usually carried out on flat or flattened network lists. This results in correspondingly high memory and computation requirements.

Therefore, such checks are dispensed with (to an extent) and the electrical response of the “circuit configuration” is “merely” simulated. However, the increasing complexity of the circuits implies that such simulations are very involved. Some connection configurations cannot be even simulated. Therefore, a quick check on a few rules before a simulation greatly shortens the development time.

Another problem lies in the checking of a network list extracted from a layout. In this regard, inventors and designers have often been content with comparing the network list extracted from the layout with the original schematic network list (i.e., LVS, Layout versus Schematic). However (within the context of order development for particular circuit parts by external companies), only the layout of the parts (but not the schematic network list) is delivered often. Therefore, an LVS check is not possible.

### SUMMARY OF THE INVENTION

It is accordingly an object of the invention to provide a method for processing data containing information about an electronic circuit having a plurality of hierarchically organized networks, a computer readable storage medium and a data processing system containing computer-executable instructions for performing the method, that overcome the hereinafore-mentioned disadvantages of the heretofore-known methods and devices of this general type, and that reduce the magnitude of the problems.

With the foregoing and other objects in view, there is provided, in accordance with the invention, a method which includes the steps of (1) retrieving data representing a network on a bottom hierarchical level; (2) processing the retrieved data to establish a network type associated with the network represented by the retrieved data; and (3) processing data representing a network hierarchically superordinate to the network represented by the retrieved data in order to allocate the network type established in step (2). The method further includes the steps of (4) processing the data in order to establish a network on a next highest hierarchical level; (5) retrieving data representing the network on the next highest hierarchical level; and (5a) repeating steps (2) to (5) on the basis of the establishment of the network on the next highest hierarchical level in step (4).

Using this method, the network type which is associated with a subordinate network is propagated, through the hierarchy, up to the “top”. Thus, when the method is completed, the physical network's network type is available in the data record for the network which is highest in the hierarchy (top network). The term “network” also covers “subnetworks”. Accordingly, the network type is available at a defined location (namely, in the top networks' data records) and can be taken into account for checking the circuit.

In accordance with another mode of the invention, the data may allocate a hierarchical level to all the networks so that the hierarchical propagation involves the circuit detecting all the networks. Accordingly, when the method has been carried out, an association exists between all the top networks and the network types of the subnetworks connected to them.

In accordance with yet another mode of the invention, the data representing the circuit can be structured such that each of the networks has an associated hierarchical level by virtue of the instances. A network can also have several associated hierarchical levels. For example, cell B (of FIG. 1) could also be instantiated directly in the root cell. Only the instances have a fixed hierarchical level associated with them in the network list. The level of the network is dependent on the instance of the cell that is currently being considered.

In accordance with a further mode of the invention, since the circuit generally contains a number of subnetworks (i.e., subordinate networks) and top networks, each set of data representing a subnetwork contains (depending on the instantiation) information regarding the associated top network. Each top network represents the highest hierarchical level for the associated subnetworks. In other words, a subnetwork can be allocated different top networks, depending on the instantiation. The fact that each subnetwork's data record contains a reference to the associated top network simplifies later-access to the network type propagated to the “top” (i.e., to the top network).

Since the electronic circuit generally has many connections, the data describing the circuit are structured such that they allocate a network to each connection while also containing information about the hierarchical organization of the connections. In accordance with another mode of the invention, the data representing the network associated with a connection on a bottom hierarchical level are retrieved.

In this embodiment, the hierarchical level of a network is established indirectly by determining the hierarchical level of the connections associated with the network. To this end, each data record associated with a connection contains a hierarchical indicator.

In accordance with a further mode of the invention, each set of data representing a connection contains information regarding a connected parent network and a connected subnetwork. If the hierarchical level of a network is determined by determining the hierarchical level of the connections associated with the network, then this additional information provides a simple way of transferring the network type from a subnetwork's data record to a parent network's data record.

In accordance with an added mode of the invention, the circuit has several instances organized in a hierarchy.

In accordance with an additional mode of the invention, each set of data representing an instance contains information regarding a match between the interconnection and another instance. This allows instances that are connected to the same networks (as other instances) to be skipped when “sifting through” the data. This makes it possible to reduce the complexity of computation for carrying out the method. This applies not only to processing the data for propagating the network types through the network, but also to “subsequent checking” of the circuit.

In accordance with yet another mode of the invention, each set of data representing an instance contains information regarding the next highest instance in the hierarchy. This simplifies sequential retrieval of the instances' associated data records in the hierarchical organization.

In accordance with yet a further mode of the invention, the method further includes the steps (for preparing a plausibility check on the circuit) of: (6) retrieving data representing a network on a top hierarchical level; (7) processing the retrieved data in order to establish the network type associated with the network represented by the retrieved data and (8) processing data representing a network hierarchically subordinate to the network represented by the retrieved data in order to allocate the network type established in step (7). It further includes the steps of (9) further processing the data in order to establish a network on a next lowest hierarchical level; and (10) retrieving data representing the network on the next lowest hierarchical level. Steps (7) to (9) are repeated on the basis of the establishment of the network on the next lowest hierarchical level in step (9).

These aforementioned steps propagate the network type associations from the top networks into the subnetworks. Hence, each network (i.e., and each subnetwork) has an associated network type available after these steps have been executed.

In accordance with yet an added mode of the invention (in a subsequent step), the data representing the circuit can be processed in order to establish the types of the networks associated with the connections.

In accordance with yet an additional mode of the invention, it is then possible to process the data in order to compare the type of a network associated with an arbitrary connection with a type which is predetermined for this connection. This can be repeated for all of the networks associated with this connection.

In accordance with a concomitant mode of the invention, this can be repeated for all of the connections of the circuit. Thus, it is possible to check the interconnection of the individual connections or of the entire circuit based on the knowledge about the types of the networks connected to the connections.

With the objects of the invention in view, there is also provided a computer readable storage medium having computer-executable instructions for performing the method of the invention.

With the objects of the invention in view, there is further provided a data processing system containing the computer-executable instructions for performing the method of the invention.

Stated simply, the method of the invention provides a way for very efficiently navigating hierarchically structured network lists. This is because, although a check can involve requesting instance-dependent information, the network list does not need to be flattened out for this purpose; rather, the instance dependability can be produced solely by referring to the top networks, and the references change during the pass through the hierarchy.

Furthermore, the concept of the network types of “similarly connected” instances allows checks to be carried out just for one respective representative of the similar instances. This saves computation time while avoiding multiple logging of errors in similar instances, which results in a faster evaluation of the “calculation results”.

Other features which are considered as characteristic for the invention are set forth in the appended claims.

Although the invention is illustrated and described herein as embodied in a method for processing data containing information about an electronic circuit having a plurality of hierarchically organized networks, a computer readable storage medium and a data processing system containing computer-executable instructions for performing the method, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a schematic circuit diagram of a hierarchical cell structure with differently connected subcells;

FIG. 2 is a flowchart illustrating the sequence of a method based on an exemplary embodiment of the invention;

FIG. 3 is an illustration of a data structure of a hierarchical network list;

FIG. 4 is an illustration of exemplary individual objects in the data structure of the circuit of FIG. 1; and

FIG. 5 is an illustration of an exemplary algorithm for propagating “network types” through a network hierarchy.

### DESCRIPTION OF THE PREFERRED EMBODIMENTS

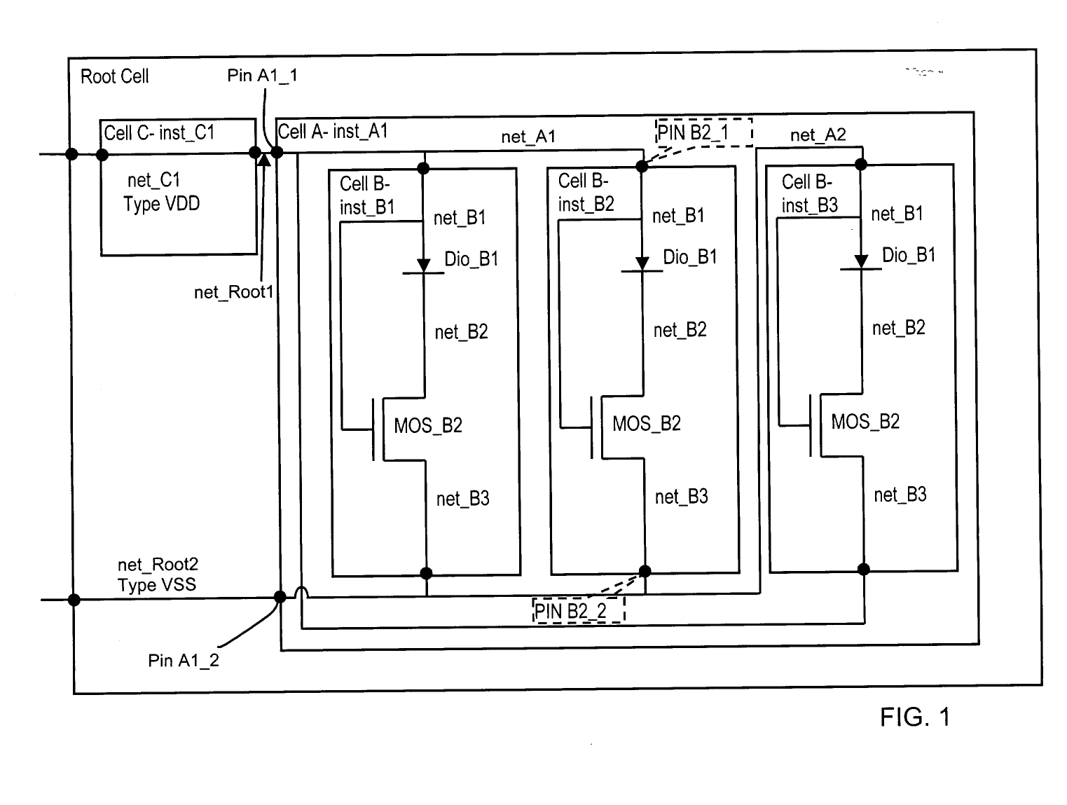

Referring now to the figures of the drawings in detail and first, particularly to FIG. 1 thereof, there is shown a schematic circuit diagram of a hierarchical cell structure with differently connected subcells.

FIG. 1 illustrates an exemplary “root cell” with cells A and C instantiated therein. Cell B is in turn instantiated in cell A. A root cell is generally a cell of the highest order containing subordinate cells, and thus corresponds to the chip. In FIG. 1, the instances inst_B1, inst_B2 and inst_B3 of cell B are placed within cell A. In inst_B1 and inst_B2, the subnetwork net_B1 for cell B is connected to Power (VDD), and net_B3 is connected to Ground (VSS), respectively. The instance inst_B3 is connected inversely. In other words, the diode Dio_B1 and the MOS transistor MOS_B2 within cell B are connected differently.

The VSS network is characterized in the root cell and hence at the highest hierarchical level. In contrast, the VDD network is characterized in the subcell C.

Overall, the cell structure of FIG. 1 has the following physical networks:

1) net_Root1+net_C1+net_A1+net_B1(inst_B1)+net_B1(inst_B2)+net_B3(inst_B3)

Network type: VDD (Power);

2) net_Root2+net_A2+net_B3(inst_B1)+net_B3(inst_B2)+net_B1 (inst_B3)

Network type: VSS (Ground); and

3) net_B2 (in each case in inst_B1, inst_B2, inst_B3)

No network type.

When the “circuit configuration” is completed, the plausibility checks indicated are performed.

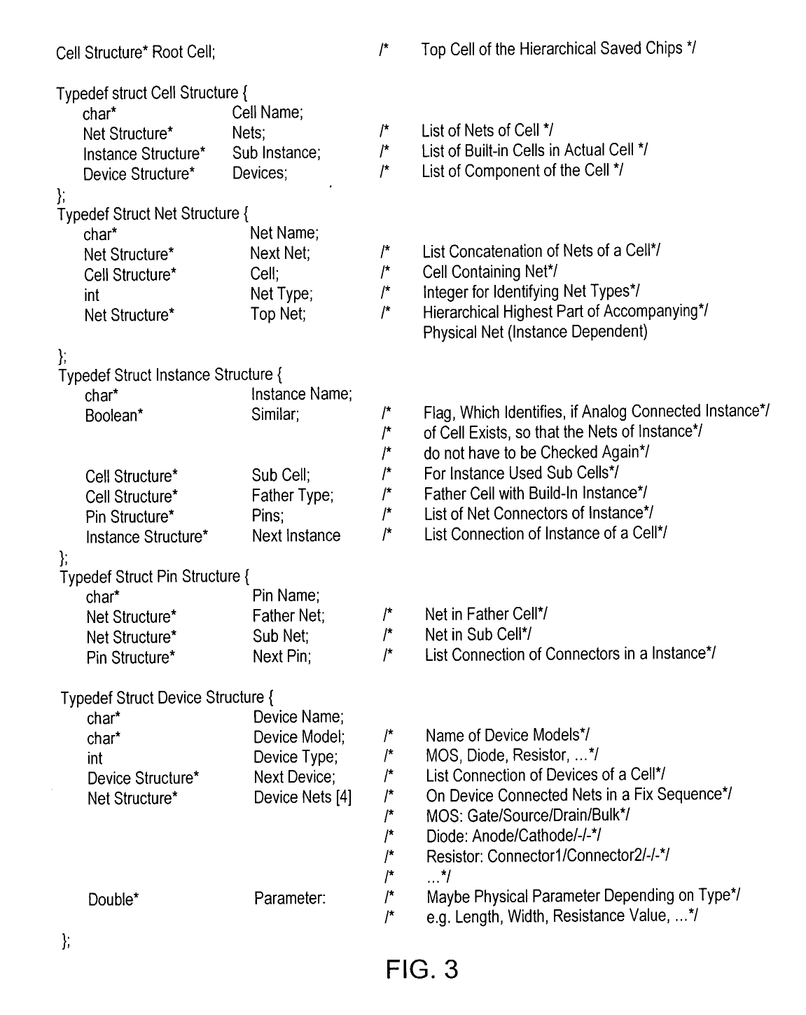

FIG. 3 shows the data structure of a hierarchical network list used as a data record for hierarchically describing a network list and for type identification for a few networks. The flag “similar” characterizes instances of a cell which are connected to the same network type as another instance of the same cell in the same parent (father/superordinate) cell. In the exemplary circuit of FIG. 1, “similar=false” applies to inst_B1 and inst_B3; however, for inst_B2, “similar=true” applies, since inst_B2 has the same connections as inst_B1. When checking the network properties, it is then sufficient to call up only one instance of the cell of this type, since the corresponding other instances have the same network properties.

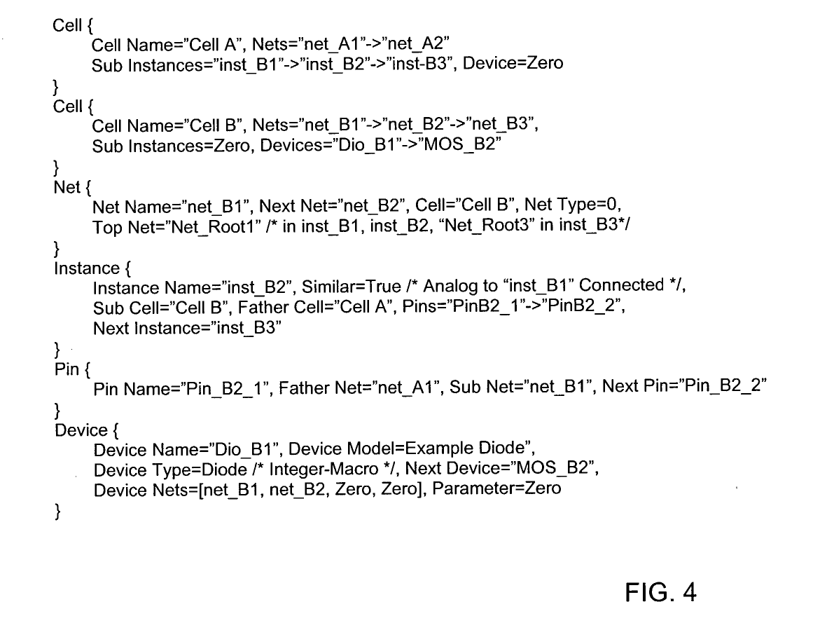

FIG. 4 shows examples of instances and cells in the circuit of FIG. 1 (which are shown in the data structure of FIG. 3). “Names” (instead of “memory addresses”) are used for the individual objects for simplicity.

The method in the illustrated exemplary embodiment propagates the network types associated with the subordinate networks or network parts to the top in the hierarchy of networks. In other words, each data record describing a network (part) of the circuit is requested, and the respective network type indicated in a data record for a network (part) is copied to the data record for the superordinate network (part) (i.e., integer network type in the data structure of FIG. 4). This is recursively repeated until the types of the networks (network parts) of the circuit are contained in the data record associated with the network (part), which is highest in the hierarchy.

The network types of the connections of the components in the individual instances can then be examined in a “pass” through the cell hierarchy.

First, the propagation of the network types will be described herein: all the cell instances are processed “bottom-up”, (i.e., starting with the subcells at the very bottom of the hierarchy, through the respective parent cells, up to the root cell). Iteration takes place (for each instance) over the list of stored connections (pins). The network type of the network connected lower in the hierarchy is retrieved (for each connection), and is transferred to the data record for the connected network that is higher in the hierarchy.

Referring again to the data structure of FIG. 4 and the circuit of FIG. 1, the connection Pin_B2_1 may be connected to the subnetwork net_B1 and to the parent network net_A1. The subnetwork net_B1 is a subnetwork which has no associated network type. Similarly, the parent network net_A1 is a subnetwork that has no associated network type. Thus, in this pass, there is no transfer of a network type from one hierarchy (net_B1) to the next highest one (net_A1). The data record for the connection Pin_B2_1 also contains a reference to the connection Pin_B2_2 belonging to the same instance. Accordingly, this connection is examined next. However, since the connection Pin_B2_2 is also connected only to subnetworks that have no associated network type, there is no transfer of the network type to the next highest hierarchy in this case either.

Subsequently, the next instance is called up (inst_B2). This is marked by the flag “Similar=TRUE”, which indicates that inst_B2 has the same connections as inst_B1. Thus, it is not necessary to check the network types. Next, inst_B3 is called up. Since inst_B3 is connected in a different way than inst_B1, the flag is “Similar=False”, and inst_B3 is checked. However, the check on the connections does not result in the transfer of network types to the next highest hierarchy, since the connections from inst_B3 are connected merely to subnetworks without a type association.

Next, the connections Pin_A1_1 and Pin_A1_2 for the “instance A1” are checked on the next highest hierarchical level, and so on. In this way, all the pins in the circuit are examined hierarchically. The network type VDD (of the circuit of FIG. 1) is transferred from network net_C1 in cell C to the network net_root1 in the root cell during this pass, while the type identification VSS is already contained in the data record for the other hierarchically highest network net_root2 for the root cell.

In a second iteration pass through the cell hierarchy, the connections of the components can be checked. In particular, this involves checking whether or not the connections of the components are linked to correct network types.

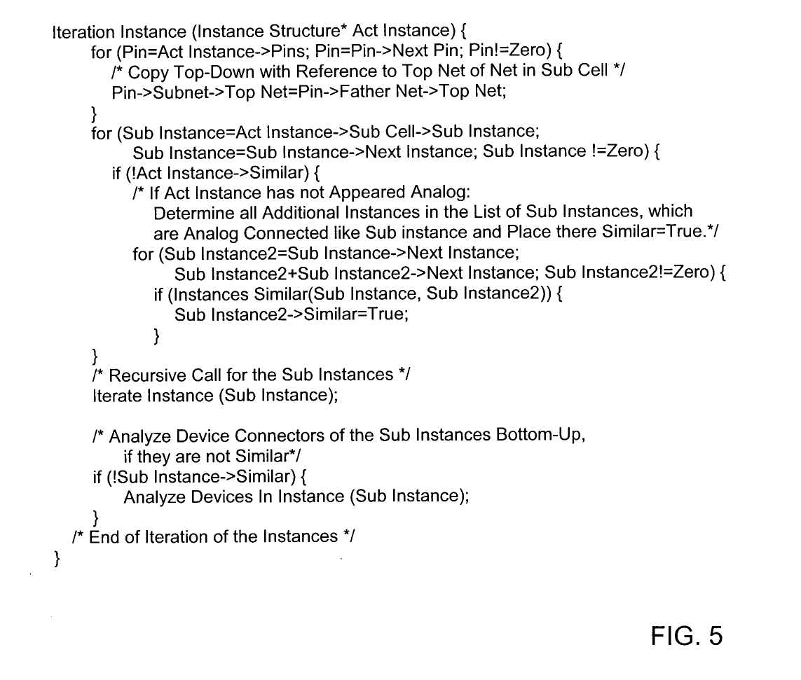

FIG. 5 shows a program written in pseudo-C for this purpose. Correct interconnection of the components is checked by accessing the network types which are now associated with the top networks.

At the start of the check, the reference to the top networks is copied to the data records associated with the networks for the subinstances (in order to be able to access them for each instance). Next, the connections of the components are analyzed “bottom-up”.

In other words, each subnetwork is allocated a reference to the top network which is above it in the hierarchy, so that each network (part) to which a component is connected has an associated network type. This association is made in a “topdown” pass through the network hierarchy. In other words, after this pass, each subnetwork, and each connection of a component, has the network type available.

Therefore (when analyzing the circuit of FIG. 1), a check reveals that the anode of the diode Dio_B1 is connected to a VDD network in the instances inst_B1 and inst_B2, and is connected to a VSS network in inst_B3.

In this case, the individual components are called up using a “bottom-up” call for the instances, with instances marked by the “similar” flag not being checked.

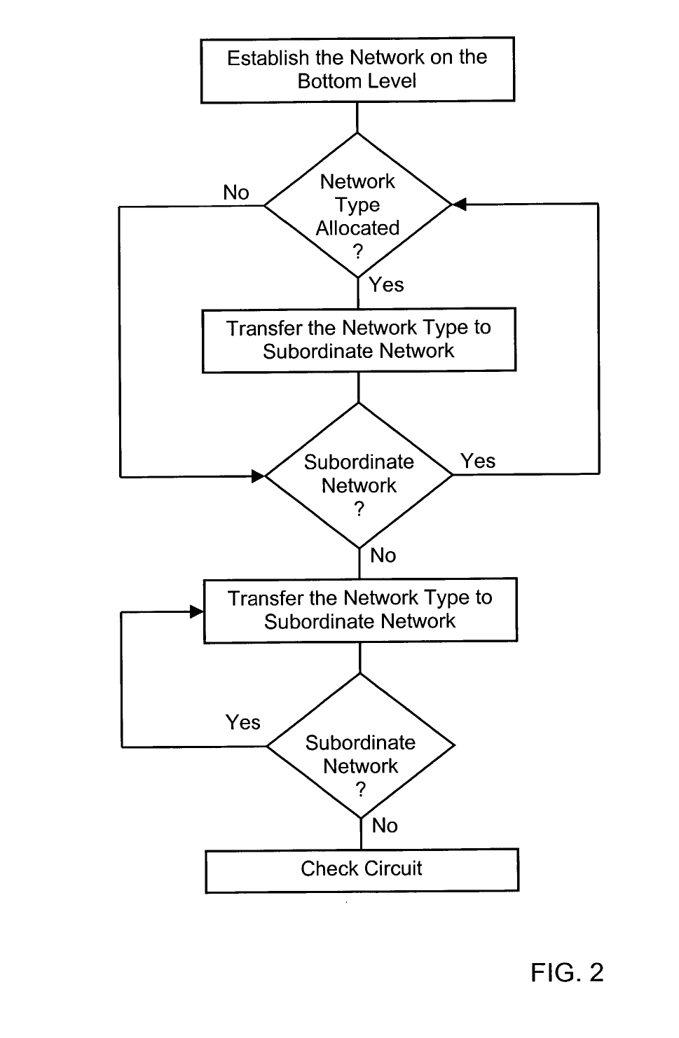

FIG. 2 illustrates the sequence of the method in accordance with an exemplary embodiment of the invention. The sequence starts (at step 1) with the establishment of the networks on the bottom hierarchical level. In step 2, a check is carried out to determine if the networks (which can also be subnetworks) have an associated network type. If this is the case, then the established network type is allocated to the next superordinate network in step 3.

Next, in step 4, it is established whether or not a further hierarchically superordinate network is available. If this is the case, steps 2 and 3 are repeated. If this is not the case, it is understood that the top network has been reached, all the circuit's subnetworks associated with this top network have been detected, and the extracted network type information has reached the top (i.e., is stored in the top network's data record). If appropriate, these steps are repeated for other top networks and the subnetworks respectively associated therewith.

In step 5, the network type associated with the top network is transferred to the data record for the next lowest networks in the hierarchy. Step 6 determines whether or not further networks (lower down in the hierarchy) exist. If this is the case, then step 5 is repeated. Otherwise, the bottom level of the network hierarchy has been reached. In other words, the network type associated with the top network is now likewise associated with all the subnetworks associated with the top network.

In step 7, the circuit is checked. This is achieved (as described above) by comparing the types of the networks associated with the circuit's connections with network types demanded on these connections. The result of the “check” can then be indicated. If necessary, any correction can also be made.

The steps of the method of FIG. 2 are executed for all the networks in the network list, since each top network can be connected to several subnetworks for a wide variety of cells. Thus, for example, the network types of net_C1 and net_A1 need to be associated with net_root1 (in the case of the circuit in FIG. 1). However, before that, net_A1 needs to obtain the network types of net_B1 and net_B2.

In other embodiments, hard-wired circuitry may be used with software instructions to implement the invention, in addition to a computer-readable medium. Thus, embodiments of the invention are not limited to any particular combination of hardware and software.

The term “computer-readable medium” refers to any medium that provides instructions. Such a medium may include but not be limited to, non-volatile media, volatile media, and transmission media. Non-volatile media includes, optical and magnetic disks. Volatile media may include dynamic memory.

Common forms of computer-readable media include a floppy disk, flexible disk, hard disk, magnetic tape, and any other magnetic medium, a CD-ROM or other optical mediums, and a RAM, a PROM, and EPROM, a FLASH-EPROM, other memory chips, and any other medium from which a computer can read.

We claim:

1. A method for processing data containing information about an electronic circuit having a plurality of hierarchically organized networks, which comprises the steps of:
(a) retrieving data representing a network on a bottom hierarchical level;
(b) processing the retrieved data to establish a network type associated with the network represented by the retrieved data;
(c) processing data representing a network hierarchically superordinate to the network represented by the retrieved data for allocating the network type established in step (b);
(d) processing the data for establishing a network on a next highest hierarchical level;
(e) retrieving data representing the network on the next highest hierarchical level; and
(e1) repeating steps (b) to (e) on the basis of the establishment of the network on the next highest hierarchical level in step (d).

2. The method according to claim 1, which further comprises the step of allocating an instance-dependent hierarchical level to each of the networks with the data.

3. The method according to claim 1, which further comprises the step of: (d1) processing the retrieved data for establishing the network on the next highest hierarchical level.

4. The method according to claim 1, which further comprises the steps of:
providing the circuit with a plurality of subnetworks and top networks, each set of data representing a subnetwork containing instance-dependent information regarding an associated top network; and
representing the highest hierarchical level for the associated subnetwork with each top network.

5. The method according to claim 1, which further comprises the steps of:
providing the circuit with a plurality of connections organized in a hierarchy;
providing each connection with an associated network; and
(a1) retrieving data representing the network associated with a connection on the bottom hierarchical level.

6. The method according to claim 5, wherein each set of data representing a connection contains information regarding a connected parent network and a connected subnetwork.

7. The method according to claim 5, which further comprises the step of allocating a hierarchical level to each of the connections with the data.

8. The method according to claim 1, wherein the circuit has a plurality of instances organized in a hierarchy.

9. The method according to claim 8, wherein each set of data representing an instance contains information about a match between an interconnection and another instance.

10. The method according to claim 8, wherein each set of data representing an instance contains information regarding the next highest instance in the hierarchy.

11. The method according to claim 1, which further comprises the steps of:
(f) retrieving data representing a network on a top hierarchical level;
(g) processing the retrieved data for establishing the network type associated with the network represented by the retrieved data;
(h) processing data representing a network hierarchically subordinate to the network represented by the retrieved data for allocating the network type established in step (g);
(i) further processing the data for establishing a network on a next lowest hierarchical level; and
(j) retrieving data representing the network on the next lowest hierarchical level, and repeating steps (g) to (i) on the basis of the establishment of the network on the next lowest hierarchical level in step (i).

12. The method according to claim 11, which further comprises the step of: (k) processing the data for checking the types of the networks associated with the connections.

13. The method according to claim 12, which further comprises the steps of:
(k1) further processing the data for comparing the type of the network associated with the connection with a predetermined type of the connection; and
(l) repeating step (k1) for all of the networks associated with the connection.

14. The method according to claim 13, which further comprises the step of:
(m) repeating steps (k1) and (l) for each connection of the circuit.

15. A computer readable storage medium, comprising computer-executable instructions for performing the method of claim 1.

16. A data processing system, comprising the computer-executable instructions of claim 15.
